(19) United States
(12) Patent Application Publication
(10) Pub. No.: US 2026/0145645 A1
(43) Pub. Date: May 28, 2026

(54) METHOD AND APPARATUS FOR TRACKING A LOCATION OF A STOLEN VEHICLE

(71) Applicants: HYUNDAI MOTOR COMPANY, Seoul (KR); KIA CORPORATION, Seoul (KR)

(72) Inventors: Seong Soo Yae, Hwaseong-si (KR); Hae Young Kwon, Hwaseong-si (KR)

(73) Assignees: HYUNDAI MOTOR COMPANY, Seoul (KR); KIA CORPORATION, Seoul (KR)

(21) Appl. No.: 19/397,330

(22) Filed: Nov. 21, 2025

(30) Foreign Application Priority Data
Nov. 26, 2024 (KR) 10-2024-0171390

(51) Int. Cl. B60R 25/33; H04B 7/155; H04W 4/029; H04W 4/46; H04W 4/80; H04W 88/04

(52) U.S. Cl. CPC B60R 25/33; H04B 7/155; H04W 4/029; H04W 4/46; H04W 4/80; H04W 88/04

(57) ABSTRACT

A computing device provided in a location cloud server interworking with a vehicle and a device over a network includes a processor configured to execute computer-readable instructions stored in a memory. The processor is configured to receive at least one theft message including identification information of a stolen vehicle and a hop count over the network and estimate and/or track a location of the stolen vehicle via radial pattern analysis based on the at least one theft message.

### CROSS-REFERENCE TO RELATED APPLICATION

This application claims the benefit of and priority to Korean t Application No. 10-2024-0171390, filed in the Korean Intellectual Property Office on Nov. 26, 2024, the entire contents of which are hereby incorporated herein by reference.

### TECHNICAL FIELD

The present disclosure relates to vehicle location tracking technology, and more particularly, relates to technologies for estimating or tracking a location of a stolen vehicle and/or a device in the stolen vehicle using an adjacent vehicle and/or an adjacent device.

### BACKGROUND

With the development of communication technology, recently, technology for checking and tracking locations of a vehicle and a device via wired/wireless communication has been actively developed.

To find existing (current) locations of devices such as an Apple AirTag, a Samsung Tag, a headset, and the like, surrounding or adjacent devices, such as smartphones, may receive broadcasting messages transmitted by the devices. The surrounding or adjacent device may check its location via a GPS receiver provided therein and may transmit the checked location information and a device identifier (ID) to a cloud server. Users may check whether there is a corresponding device nearby or where the device was last found via a specific application (app) interworking with the cloud server, which may be installed in their smartphones.

However, it is difficult for currently mass-produced vehicles to identify stolen states or locations of the vehicles. If a vehicle moves in a state in which the door is opened with the key of the vehicle and the vehicle's ignition is off, a notification that the door of the vehicle is opened may be only provided and a theft situation of the vehicle may fail to be separately notified, depending on current mass production specifications. Thus, because with a conventional notification scheme output from the vehicle it is difficult to clearly distinguish an actual theft situation, a situation in which only the door is opened with a key, or a situation in which the door is opened from the outside of the vehicle, it is impossible to determine a theft state and it is impossible to suitably respond if the actual theft situation occurs.

Furthermore, conventional vehicle location tracking has a limitation in that it is possible to track the location only in a state in which a GPS receiver and a vehicle terminal capable of performing remote wireless communication, such as mobile communication and/or telematics communication, are provided in the vehicle, making it possible to check the location and perform wireless communication at a corresponding time point.

As an example, even if an app service for “my car location sharing” is used, current location information of the tracking target vehicle may be transmitted to a server only if a long range wireless communication function of a vehicle to be tracked is activated and the GPS receiver is operable to check and track a location of the vehicle. Another vehicle and a user device may then identify a location of the vehicle.

However, if a mobile communication module is not provided or it is unable to transmit location information to the server, for example due to expiration of a free period of use of a vehicle connected service, such as Blue Link, Kia Connected, Genesis Connected, or the like, it is impossible to identify a location of the vehicle. Furthermore, even if it is possible to perform long range wireless communication, if the GPS receiver fails, the GPS receiver is removed, or power is not supplied to the GPS receiver, including, for example, if a thief intentionally blocks power supplied to an infotainment system, it may be impossible to obtain location information.

### SUMMARY

The present disclosure has been made to solve the above-mentioned problems occurring in the prior art while advantages achieved by the prior art are maintained intact.

Aspects of the present disclosure provide a technology for more robustly checking and tracking a location of a stolen vehicle to address the above-mentioned conventional problems.

Aspects of the present disclosure provide a method and apparatus for tracking a location of a stolen vehicle using an adjacent vehicle and an adjacent device.

Other aspects of the present disclosure provide a method and apparatus for tracking a location of a stolen vehicle to check and track a location of the stolen vehicle and/or a device regardless of communication options and/or resources of all vehicles and/or devices.

Other aspects of the present disclosure provide a method and an apparatus for tracking a location of a stolen vehicle to apply a separate vehicle setting mode called a theft detection mode and clearly identify general vehicle usage and theft to respond to the theft.

Other aspects of the present disclosure provide a method and an apparatus for tracking a location of a stolen vehicle using an adjacent vehicle and an adjacent device to adaptively interwork with the adjacent vehicle and/or the adjacent device via short range wireless communication depending on a state and a resource availability state of the stolen vehicle upon theft detection to more robustly check and track a location of the stolen vehicle.

Other aspects of the present disclosure provide a method and an apparatus for tracking a location of a stolen vehicle using an adjacent vehicle and an adjacent device to limit a hop count of relay communication using short range wireless communication to prevent data explosion on a network.

Other aspects of the present disclosure provide a location cloud server for performing tracking radial pattern analysis based on location information collected from an adjacent vehicle and/or an adjacent device to check and track a location of a stolen vehicle.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a computing device is provided in a location cloud server interworking with a vehicle and a device over a network. The computing device includes a memory storing computer-readable instructions and a processor configured to execute the computer-readable instructions. The processor is configured to receive at least one theft message including identification information of a stolen vehicle and a hop count over the network. The processor is also configured to estimate and/or track a location of the stolen vehicle via radial pattern analysis based on the at least one theft message.

In an embodiment, the theft message may include a first theft message directly received from the stolen vehicle and a second theft message received from an adjacent vehicle and/or an adjacent device around the stolen vehicle. Information included in the first and second theft messages may be dynamically generated according to a communication option and a resource state of the vehicle and/or the device.

In an embodiment, the second theft message may be transmitted by the stolen vehicle via short range wireless communication, may be relayed and updated to at least one adjacent vehicle and/or at least one adjacent device, and may be received via long range wireless communication. An initial hop count of the second theft message transmitted by the stolen vehicle may be set to 0. The hop count may increase by 1 as the relaying is in progress.

In an embodiment, the second theft message may include relay information corresponding to each of the at least one adjacent vehicle and/or the at least one adjacent device. The relay information may include at least one of location information or time information when the relay information is generated, according to the communication option and the resource state of the adjacent vehicle and/or the adjacent device.

In an embodiment, the hop count may increase by the number of time that the second theft message is relayed via the short range wireless communication. A radial pattern radius corresponding to a current location of the adjacent vehicle or the adjacent device may be determined based on the hop count included in the second theft message.

In an embodiment, the processor may be configured to perform the radial pattern analysis based on determining that the number of the second theft messages received during a unit time in response to the stolen vehicle is greater than or equal to a certain reference value. The processor may also be configured to estimate an area where radial patterns for each second theft message overlap with each other as a current location of the stolen vehicle. The processor may further be configured to connect the estimated current location over time to track a movement route of the stolen vehicle.

In an embodiment, relaying the second theft message via the short range wireless communication may be stopped based on the increased hop count being greater than or equal to a certain maximum hop count.

In an embodiment, the processor may be configured to collect information about a traffic state of the network and transmit an end of tracking message to the adjacent vehicle and/or the adjacent device which transmit(s) the second theft message via the long range wireless communication, depending on the traffic state.

In an embodiment, the short range wireless communication may include at least one of Bluetooth communication, wireless-fidelity (Wi-Fi) communication, ZigBee communication, or ultra wideband (UWB) communication. The long range wireless communication may include at least one of long term evolution (LTE) communication, 5G new radio access network (RAN) (5G NR) communication, or dedicated vehicle wireless communication.

According to another aspect of the present disclosure, a computing device is provided in a vehicle interworking with a location cloud server over a network. The computing device includes a memory storing computer-readable instructions and a processor configured to execute the computer-readable instructions. The processor is configured to detect whether theft occurs based on a theft detection mode being activated. The processor is also configured to enter a theft tracking mode based on detecting the theft to determine a communication scheme corresponding to a communication option and a resource state of the vehicle. The processor is further configured to transmit a theft message using the determined communication scheme. The theft message may be directly transmitted to the location cloud server based on the determined communication scheme being long range wireless communication. The theft message may be relayed and transmitted to the location cloud server via an adjacent vehicle and/or an adjacent device around the vehicle based on the determined communication scheme being short range wireless communication.

According to another aspect of the present disclosure, a method is provided for tracking a location of a stolen vehicle in a location cloud server interworking with a vehicle and a device over a network. The method includes receiving at least one theft message including identification information of a stolen vehicle and a hop count over the network. The method also includes estimating and/or tracking a location of the stolen vehicle via radial pattern analysis based on the at least one theft message.

In an embodiment, the theft message may include a first theft message directly received from the stolen vehicle and a second theft message received from an adjacent vehicle and/or an adjacent device around the stolen vehicle. Information included in the first and second theft messages may be dynamically generated according to a communication option and a resource state of the vehicle and/or the device.

In an embodiment, the second theft message may be transmitted by the stolen vehicle via short range wireless communication, may be relayed and updated to at least one adjacent vehicle and/or at least one adjacent device, and may be received via long range wireless communication. An initial hop count of the second theft message transmitted by the stolen vehicle may be set to 0. The hop count may increase by 1 as the relaying is in progress.

In an embodiment, the second theft message may include relay information corresponding to each of the at least one adjacent vehicle and/or the at least one adjacent device. The relay information may include at least one of location information or time information when the relay information is generated, depending on the communication option and the resource state of the adjacent vehicle and/or the adjacent device.

In an embodiment, the hop count may increase by the number of times that the second theft message is relayed via the short range wireless communication. A radial pattern radius corresponding to a current location of the adjacent vehicle or the adjacent device may be determined based on the hop count included in the second theft message.

In an embodiment, the radial pattern analysis may be performed based on the number of the second theft messages, related to the stolen vehicle, received during a unit time being greater than or equal to a certain reference value. An area where radial patterns for each second theft message overlap with each other may be estimated as a current location of the stolen vehicle. The estimated current location may be connected over time to track a movement route of the stolen vehicle.

In an embodiment, the relaying of the second theft message via the short range wireless communication may be stopped based on the increased hop count being greater than or equal to a certain maximum hop count.

In an embodiment, the method may further include collecting information about a traffic state of the network and transmitting an end of tracking message to the adjacent vehicle and/or the adjacent device which transmit(s) the second theft message via the long range wireless communication, depending on the traffic state.

In an embodiment, the short range wireless communication may include at least one of Bluetooth communication, wireless-fidelity (Wi-Fi) communication, ZigBee communication, or ultra wideband (UWB) communication. The long range wireless communication may include at least one of long term evolution (LTE) communication, 5G new radio access network (RAN) (5G NR) communication, or dedicated vehicle wireless communication.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing for describing a configuration of a system for tracking a location of a stolen vehicle according to an embodiment of the present disclosure;

FIG. 2 is a block diagram for describing a configuration of a vehicle according to an embodiment of the present disclosure;

FIG. 3 is a block diagram for describing a structure of a vehicle theft controller according to an embodiment of the present disclosure;

FIG. 4 is a block diagram for describing a structure of a device according to an embodiment of the present disclosure;

FIG. 5 is a block diagram for describing a configuration of a location cloud server according to an embodiment of the present disclosure;

FIG. 6 is a drawing for describing a method for estimating a location of a stolen vehicle via radial pattern analysis according to an embodiment of the present disclosure;

FIG. 7 is a drawing for describing a method for tracking a location of a stolen vehicle via radial pattern analysis according to an embodiment of the present disclosure;

FIG. 8 is a flowchart for describing a method of a stolen vehicle according to embodiment of the present disclosure;

FIG. 9 is a flowchart for describing a method performed by a vehicle or a device located around a stolen vehicle according to embodiment of the present disclosure;

FIG. 10 is a flowchart for describing a method of a location cloud server according to embodiment of the present disclosure; and

FIG. 11 illustrates a computing system according to an embodiment of the present disclosure.

### DETAILED DESCRIPTION

Hereinafter, some embodiments of the present disclosure are described in detail with reference to the accompanying drawings. In adding the reference numerals to the components of each drawing, it should be noted that the identical components are designated by the identical numerals even when the components are displayed on different drawings. Further, in describing the embodiment of the present disclosure, where it was determined that a detailed description of well-known features or functions would obscure the gist of the present disclosure, the detailed description thereof has been omitted.

In describing the components of the embodiment according to the present disclosure, terms such as first, second, “A”, “B”, (a), (b), and the like may be used. These terms are merely intended to distinguish one component from another component. These terms do not limit the nature, sequence, or order of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equivalent to the contextual meanings in the relevant field of art, and should not be interpreted as having ideal or excessively formal meanings unless clearly defined as having such in the present application.

In the present disclosure, when a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

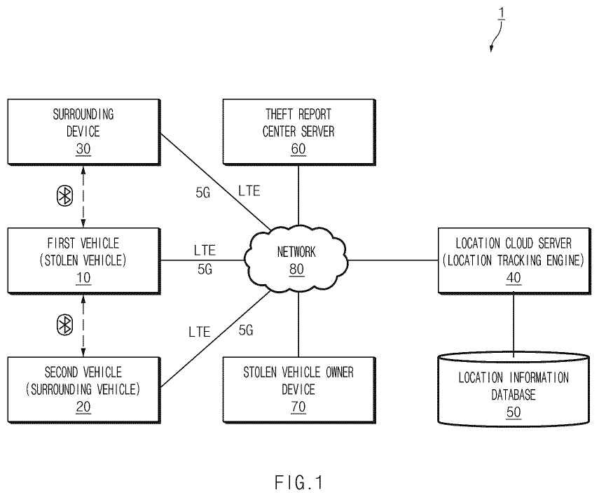

Hereinafter, embodiments of the present disclosure are described in more detail with reference to FIGS. 1-11.

FIG. 1 is a drawing for describing a configuration of a system for tracking a location of a stolen vehicle, according to an embodiment of the present disclosure.

Referring to FIG. 1, a system 1 for tracking a location of a stolen vehicle may include at least one of a first vehicle 10, a second vehicle 20, a surrounding (also referred to herein as “adjacent”) device 30, a location cloud server 40, a location information database 50, a theft report center server 60, a stolen vehicle owner device 70, or a network 80.

In FIG. 1, the first vehicle 10 may be a stolen vehicle and the second vehicle 20 may be a surrounding (also referred to herein as “adjacent”) vehicle located around (e.g., near or in the vicinity of) the stolen vehicle. It is noted that “surrounding” and “adjacent” may be used herein interchangeably to refer to a vehicle or a device that is located around (e.g., near or in the vicinity of) the stolen vehicle.

The network 80 may include a wired network including the Internet and a wireless network. As an example, the wireless network may include, but is not limited to, a commercial mobile communication network, such as 4G long term evolution (LTE), 5G new radio access network (NR). Additionally, or alternatively, the wireless network may include a dedicated vehicle wireless communication network, such as dedicated short-range communication (DSRC), wireless access in vehicular environments (WAVE), cellular vehicle to everything (C-V2 X), a wireless-fidelity (Wi-Fi) network, and the like.

If a theft detection mode is activated, the first vehicle 10 may detect whether theft occurs using a theft sensor provided therein. As an example, when the theft detection mode is not released and the vehicle is in an ignition off state, the first vehicle 10 may determine that a theft situation occurs if the door of the vehicle is opened or the handle of the vehicle is pulled in a state in which the door of the vehicle is locked. As another example, as a main battery of the first vehicle 10 is disconnected, the first vehicle 10 may determine that the theft situation occurs if power supplied to an infotainment system is blocked. To avoid being tracked, vehicle thieves may remove a main battery of a vehicle from the vehicle or may cut a connection line for supplying power to a vehicle system. The first vehicle 10 may monitor power supplied from the main battery and may determine whether power supply is blocked.

If theft is detected, the first vehicle 10 may enter a theft tracking mode.

If the main battery (e.g., B+−) is removed in the theft tracking mode, the first vehicle 10 may initiate short range wireless communication using power of a super condenser (or a super capacitor battery) provided in the first vehicle 10. As an example, the short range wireless communication may be Bluetooth communication, but this is only an example and the present disclosure is not limited thereto. The short range wireless communication may be any one of wireless-fidelity (Wi-Fi) communication, ultra wideband (UWB) communication, or ZigBee depending the implementation, as would be understood by those having ordinary skill in the art. A Bluetooth (BT) module of an infotainment system, a BT module used in a digital key, a BT module used in a tire pressure management system (TPMS), and the like may be mounted on most vehicles. Thus, most vehicles include at least one BT module.

The first vehicle 10 may transmit a theft tracking command message including a vehicle identifier of the first vehicle 10, for example, a vehicle identification number (VIN), and a hop count (N). In an embodiment, the theft tracking command message may further include at least one of current location information, route setting information, or current time information of the first vehicle 10. The hop count (N) may be set to 0. In an example, the hop count 0 may refer to the stolen vehicle itself. In an embodiment, the first vehicle 10 may transmit the theft tracking command message at a certain period, for example, a period of 1 second, before a certain end of tracking message (Etm) is received from the location cloud server 40. In an embodiment, Etm may include at least one of a VIN, a maximum hop count, such as a maximum relay count, or an Etm generation time.

If the theft tracking command message is received via the short range wireless communication, the second vehicle 20 and/or the adjacent device 30 may add a hop count, location information, and time information corresponding to the second vehicle 20 and/or the adjacent device 30 to the received theft tracking command message to update the theft tracking command message and may transmit the updated theft tracking command message to the location cloud server 40 over the network 80, if it is possible to perform long range wireless communication. If it is impossible to perform the long range wireless communication after updating the theft tracking command message, the second vehicle 20 and/or the adjacent device 30 may transmit the updated theft tracking command message via the short range wireless communication to relay the theft tracking command message to another adjacent vehicle and/or another surrounding device. As an example, the long range wireless communication may be any one of LTE communication, 5G NR communication, or dedicated vehicle wireless communication.

The location cloud server 40 according to an embodiment may collect information about a network traffic state and may transmit Etm based on the network traffic state. In an embodiment, Etm may be transmitted to a surrounding or adjacent vehicle and/or a surrounding device that transmit(s) the theft tracking command message to the location cloud server 40.

If the theft tracking command message is received, the location cloud server 40 may identify a stolen vehicle and may transmit a theft report message including at least one of an identifier of the identified stolen vehicle or location information of the identified stolen vehicle to the theft report center server 60 over the network 80.

If the theft tracking command message is directly received from the first vehicle 10, the location cloud server 40 may determine a current location of the first vehicle 10 to perform stolen vehicle tracking, based on the location information included in the theft tracking command message.

If the theft tracking command message is received from the second vehicle 20 and/or the surrounding device 30 rather than the first vehicle 10, the location cloud server 40 may estimate and track a location of the stolen vehicle based on location information and time information included in the received theft tracking command message.

The location cloud server 40 according to an embodiment may perform radial pattern analysis based on relay information collected from the second vehicle 20 and/or the surrounding device 30 and may check and track the location of the stolen vehicle. The radial pattern analysis method based on the relay information, according to an embodiment, is described in more detail below.

The location cloud server 40 may provide a control mechanism for preventing data explosion on the network 80 due to excessive relaying occurrence by a surrounding vehicle and/or a surrounding device around the stolen vehicle.

As an example, the location cloud server 40 may limit (or define) the number of pieces of relay information collected per stolen vehicle. A control method based on the number of pieces of relay information may be advantageous for estimating and tracking a location of a stolen vehicle that has limited movement or is stopping, by limiting the maximum number of pieces of relay information collected per stolen vehicle or defining the minimum number of pieces of relay information necessary to estimate the location of the stolen vehicle. The location cloud server 40 may perform radial pattern analysis based on location information that is less than or equal to the certain maximum number of pieces of location information collected after a specific time point, thus checking and tracking a location of the stolen vehicle.

As another example, the location cloud server 40 may predefine a validity time of relay information (or location information) collected in relation to the stolen vehicle after a specific time point and may perform radial pattern analysis based on relay information received within the validity time to estimate and track a location of the stolen vehicle. The time-based control method may be useful, for example, if the stolen vehicle is moving. For example, because the radial pattern analysis is performed only during the validity time at intervals of a fixed time, the time-based control method may be advantageous to track a movement route together with checking an approximate location of the stolen vehicle.

The stolen vehicle owner device 70 may be loaded with an app for checking and tracking a location of the stolen vehicle (hereinafter referred to as a “theft tracking app”). A stolen vehicle owner may access the location cloud server 40 via the theft tracking app and may check information about checking and tracking the location of the stolen vehicle.

The location cloud server 40 may obtain route setting information of the first vehicle 10 directly from the first vehicle 10 or indirectly via the second vehicle 20 and/or the surrounding device 30. The location cloud server 40 according to an embodiment may transmit a certain tracking command message including the route setting information of the first vehicle 10 to the second vehicle 20. The second vehicle 20 may transmit a tracking acceptance message corresponding to the received tracking command message, may set (e.g., may automatically set) a route included in the received tracking command message in navigation of the second vehicle 20, and may track the first vehicle 10. If the stolen vehicle tracking is accepted by the stolen vehicle owner, the location cloud server 40 according to an embodiment may transmit the tracking command message to the second vehicle 20. The location cloud server 40 according to an embodiment may transmit the tracking command message to the surrounding device 30. In this case, the surrounding device 30 may set (e.g., may automatically set) its navigation using the route of the stolen vehicle, that is included in the tracking command message. A user of the surrounding device 30 may track the stolen vehicle based on guidance of the navigation.

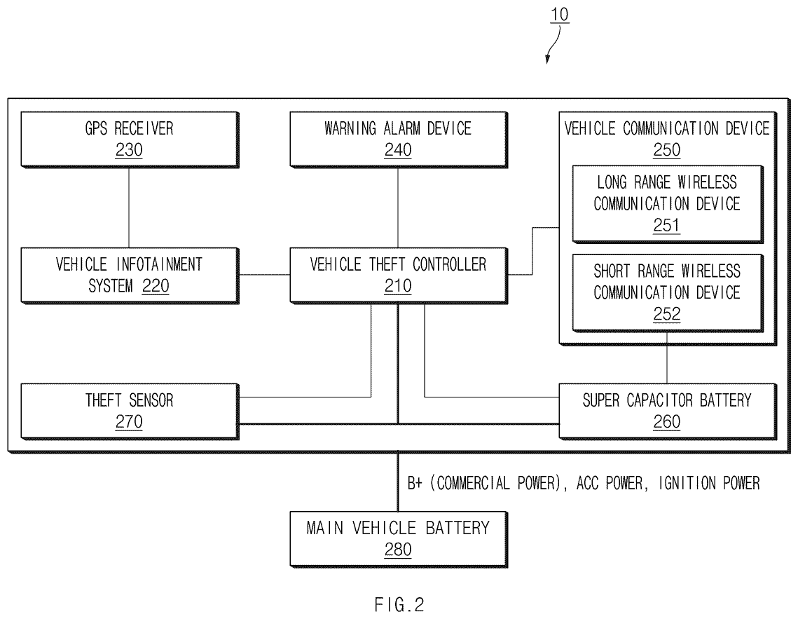

FIG. 2 is a block diagram for describing a configuration of a vehicle according to an embodiment of the present disclosure.

FIG. 2 is a drawing for describing a configuration of the first vehicle 10 of FIG. 1, according to an embodiment.

A second vehicle 20 may also include the same or similar configuration to the first vehicle 10. Operation of the second vehicle 20, according to an embodiment, is described in more detail below.

Referring to FIG. 2, the first vehicle 10 may include at least one of a vehicle theft controller 210, a vehicle infotainment system 220, a GPS receiver 230, a warning alarm device 240, a vehicle communication device 250, a super capacitor battery 260, a theft sensor 270, or a main vehicle battery 280.

If a theft detection mode is activated, the vehicle theft controller 210 may detect whether theft occurs based on sensing information received from the theft sensor 270.

As an example, the theft detection mode may be activated via an authentication means, such as a password or biometric identification, after a certain vehicle app is executed. However, this is only an example and the present disclosure is not limited thereto. For example, in another embodiment, the theft detection mode may be automatically activated, if a vehicle door is set to lock after a user sets the theft detection mode on a vehicle menu and alights from a vehicle. The theft detection mode may be released after the user executes the vehicle app, enters a password, and selects a release menu. However, this is only an example and the present disclosure is not limited thereto. For example, in another embodiment, the theft detection mode may be released after the user unlocks the vehicle door using a vehicle key or a smart key, enters the password on the vehicle menu, and selects the release mode.

The vehicle theft controller 210 may enter a theft tracking mode upon theft detection and may obtain at least one of current location information, route setting information, or current time information of the first vehicle 10 from the vehicle infotainment system 220.

The vehicle theft controller 210 may control to output a certain warning alarm via the warning alarm device 240 upon theft detection.

The vehicle theft controller 210 may detect whether power from the main vehicle battery 280 is blocked and/or whether the main vehicle battery 280 is removed.

The vehicle communication device 250 may include a long range wireless communication device 251 and a short range wireless communication device 252.

The vehicle theft controller 210 may determine whether it is possible to use the long range wireless communication device 251 and may activate the short range wireless communication device 252 if it is impossible to perform long range wireless communication.

If it is possible to perform the long range wireless communication after entering the theft tracking mode, the vehicle theft controller 210 may transmit a theft tracking request message to a location cloud server 40 via the long range wireless communication device 251. In an embodiment, the theft tracking request message may include at least one of vehicle identification information, current location information, route setting information, current time information, or hop count information corresponding to the first vehicle 10. As an example, the current location information may include latitude/longitude information, but this is only an embodiment. If indoor navigation is loaded into the first vehicle 10, the current location information may further include location and state information in a building, for example, the number of floors and/or parking location information and parking/stop state information.

If it is impossible to supply power from the main vehicle battery 280, the vehicle theft controller 210 may control to supply power to the short range wireless communication device 252 via the super capacitor battery 260.

If it is impossible to perform long range wireless communication, the vehicle theft controller 210 may transmit a theft tracking command to a surrounding vehicle 20 and/or a surrounding device 30 via the short range wireless communication device 252.

The vehicle theft controller 210 according to an embodiment may receive commercial power from the super capacitor battery 260. The super capacitor battery 260 may have millions of charge/discharge cycles, may have a smaller weight and size than the main vehicle battery 280, and may have large degree of freedom of implementation in a vehicle. Thus, the super capacitor battery (or a super condenser) 260 may be mounted at a location at which it is impossible to be removed by a vehicle thief.

If the GPS receiver 230 is not provided or does not normally operate in the first vehicle 10, because it is impossible to check a current location, the first vehicle 10 may transmit a theft tracking command via the short range wireless communication device 252 and may control to be able to check and track its location by means of the surrounding vehicle 20 and/or the surrounding device 30.

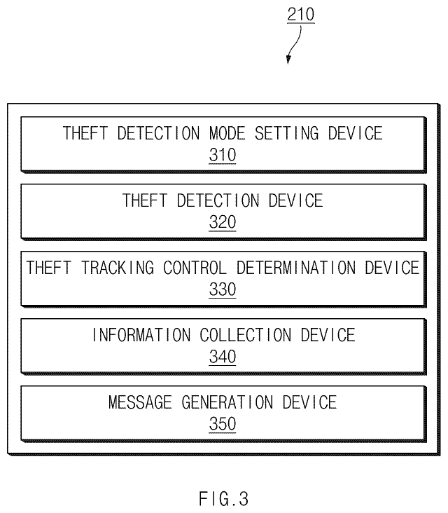

FIG. 3 is a block diagram for describing a structure of a vehicle theft controller according to an embodiment of the present disclosure.

Referring to FIG. 3, a vehicle theft controller 210 may include a theft detection mode setting device 310, a theft detection device 320, a theft tracking control determination device 330, an information collection device 340, and a message generation device 350.

The theft detection mode setting device 310 may activate or deactivate a theft detection mode based on an external input signal.

If the theft detection mode is activated, the theft detection device 320 may detect whether theft occurs based on sensing information received from a theft sensor 270.

The theft tracking control determination device 330 may enter a theft tracking mode upon theft detection and may determine whether to use any communication scheme based on a communication option (e.g., whether or not long range communication and/or short range communication are available) and a current resource state of a vehicle.

The information collection device 340 may collect information capable of being currently collected from the vehicle. As an example, the information collection device 340 may collect at least one of vehicle identification information, current location information, route setting information, or current time information.

The message generation device 350 may generate a message to be transmitted according to the communication scheme determined by the theft tracking control determination device 330. If the determined communication scheme is a long range wireless communication scheme, the message generation device 350 may generate and transmit a theft tracking request message including the information collected by the information collection device 340 and a hop count to a location cloud server 40 over a network 80. If the determined communication scheme is a short range wireless communication scheme, the message generation device 350 may transmit a theft tracking command message including the information collected by the information collection device 340 and the hop count to a surrounding vehicle 20 and/or a surrounding device 30 via short range wireless communication.

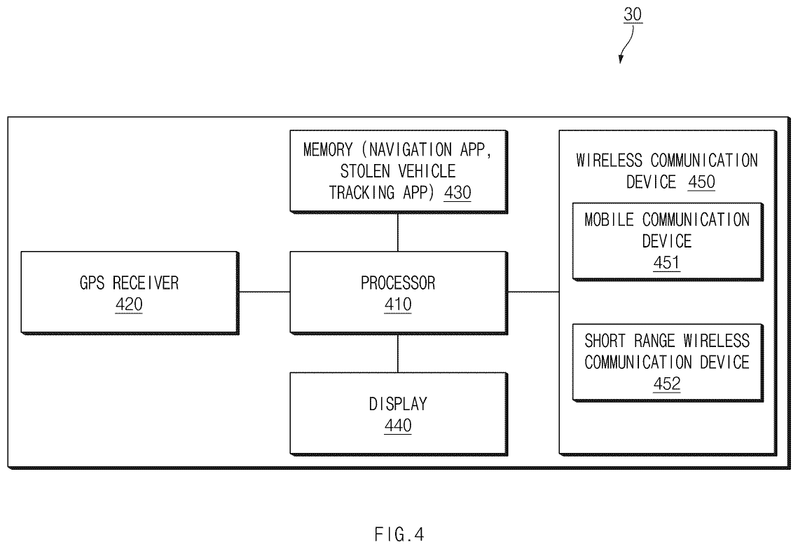

FIG. 4 is a block diagram for describing a structure of a device according to an embodiment of the present disclosure.

FIG. 4 is a drawing for describing a configuration and an operation of a surrounding device 30 of FIG. 1, according to an embodiment. A stolen vehicle owner device 70 may also include the same or similar configuration to the surrounding device 30. Operation of the stolen vehicle owner device 70, according to an embodiment, is described in more detail below.

Referring to FIG. 4, the surrounding device 30 may include a processor 410, a GPS receiver 420, a memory 430, a display 440, and a wireless communication device 450.

The processor 410 may control the overall operation and the input and output of the surrounding device 30.

The wireless communication device 450 may include a mobile communication device 451 and a short range wireless communication device 452. The mobile communication device 451 may support at least one of 4G LTE communication or 5G NR communication. The short range wireless communication device 452 may include at least one of Bluetooth communication, ZigBee communication, or UWB communication.

The memory 430 may maintain a navigation app and a stolen vehicle tracking app. The processor 410 may execute the navigation app and/or the stolen vehicle tracking app based on an external input signal.

If a theft tracking command message is received from a first vehicle 10 via the short range wireless communication device 452, the processor 410 may generate relay information including current location information, current time information, and a hop count corresponding to the surrounding device 30. In an embodiment, the processor 410 may set a hop count to 1.

If connected with the mobile communication network, the processor 410 may transmit a theft tracking command message, to which the relay information is added, to a location cloud server 40 via the mobile communication device 451.

If it is impossible to use the mobile communication network, the processor 410 may transmit the theft tracking command message, to which the relay information is added, via the short range wireless communication device 452.

The processor 410 may receive a theft tracking command message via short range wireless communication from another surrounding vehicle and/or another surrounding device.

If the theft tracking command message is received from the other surrounding vehicle and/or the other surrounding device, the processor 410 may increase the hop count by 1 to generate relay information and may transmit a theft tracking command message including the relay information to the other surrounding vehicle and/or the other surrounding device via short range wireless communication or may transmit the theft tracking command message to the location cloud server 40 via the mobile communication network, depending on whether it is possible to use the mobile communication network.

In an embodiment, if the increased hop count reaches a certain maximum hop count value, the processor 410 may ignore the received theft tracking command message.

In another embodiment, if a time that elapses after the theft tracking command message is initially generated is greater than a certain maximum time, the processor 410 may ignore the received theft tracking command message.

Accordingly, embodiments of the present disclosure may limit the number of times that the theft tracking command message is relayed and/or a time when the theft tracking command message is relayed, thus preventing unnecessary relay communication from occurring.

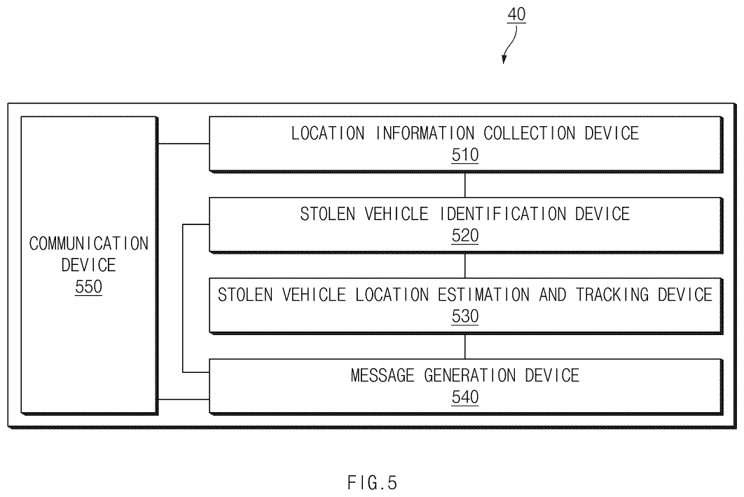

FIG. 5 is a block diagram for describing a configuration of a location cloud server according to an embodiment of the present disclosure.

Referring to FIG. 5, a location cloud server 40 may include a location information collection device 510, a stolen vehicle identification device 520, a stolen vehicle location estimation and tracking device 530, a message generation device 540, and a communication device 550.

The information collection device 510 may collect information included in a theft message, for example, a theft tracking request message and/or a theft tracking command message. In an embodiment, relay information may be included in the theft tracking command message.

The stolen vehicle identification device 520 may identify a stolen vehicle, based on a vehicle identifier included in the collected information. As an example, the vehicle identifier may be a VIN. However, this is only an example and the present disclosure is not limited thereto. For example, in another embodiment, the vehicle identifier may be a vehicle license plate or a vehicle phone number. The stolen vehicle identification device 520 according to an embodiment may control the message generation device 540 to immediately transmit a certain theft warning notification message including a stolen vehicle identifier identified if receiving the theft message to a theft report center server 60 and/or a stolen vehicle owner device 70.

The stolen vehicle location estimation and tracking device 530 may check (or estimate) and track a location of a stolen vehicle via radial pattern analysis based on the collected location information, time information, and hop count.

The stolen vehicle location estimation and tracking device 530 may provide the message generation device 540 with the currently estimated location information and the currently tracked information of the stolen vehicle.

The message generation device 540 may transmit a theft tracking message including the currently estimated location information and the currently tracked information of the stolen vehicle to the theft report center server 60 and/or the stolen vehicle owner device 70 via the communication device 550.

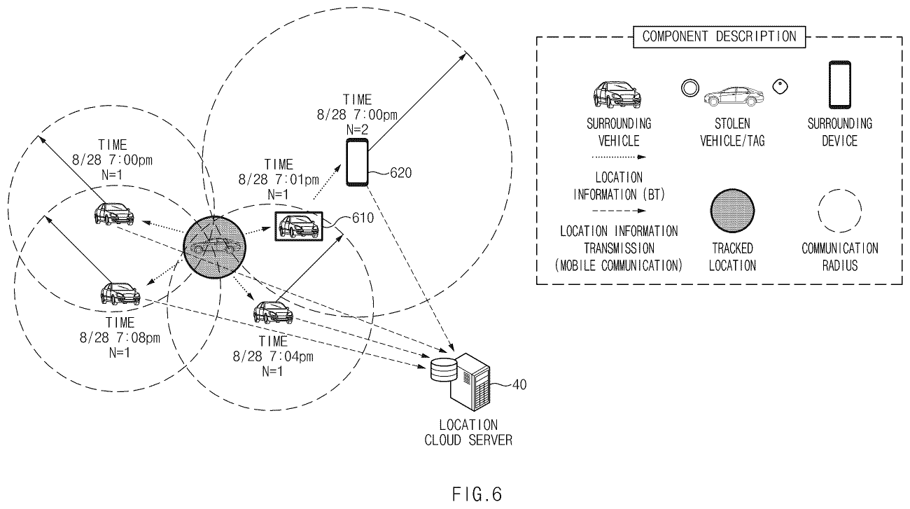

FIG. 6 is a drawing for describing a method for estimating a location of a stolen vehicle via radial pattern analysis according to an embodiment of the present disclosure.

Referring to FIG. 6, if the number of pieces of maximum location information necessary to estimate a location of a stolen vehicle is limited to 4, a location cloud server 40 may perform radial pattern analysis on the basis of 4 pieces of relay information received related to the stolen vehicle (e.g., based on a VIN) between 7 p.m. and 7:10 p.m. on August 28 to estimate a current location of the stolen vehicle. The location cloud server 40 may draw a radial pattern corresponding to 4 pieces of relay information collected after 7 μm. The location cloud server 40 may estimate a portion where four radial patterns overlap with each other as the tracked location. As an example, the tracked location may be displayed as about a radius of 2 m and GPS coordinates corresponding to the tracked location may be displayed at one side of the radius of 2 m. As shown in FIG. 6, a radius of the radial pattern corresponding to each of pieces of relay information may be determined based on a hop count value included in the relay information. As an example, in hop count 2, a radial pattern with a radius twice hop count 1 may be drawn.

In an example, a surrounding vehicle and/or a surrounding device in which it is impossible to perform long range wireless communication may bypass and transmit the received theft tracking command message to another surrounding vehicle and/or another surrounding device via short range wireless communication. Referring to FIG. 6, if it is impossible for a surrounding vehicle 610 to perform long range wireless communication, the surrounding vehicle 610 may add its relay information to the received theft tracking command message and may deliver the theft tracking command message a surrounding device 620 again. The surrounding device 620 may add its relay information to the received theft tracking command message and may transmit the theft tracking command message to a location cloud server 40 via long range wireless communication.

As shown in FIG. 6, a method for estimating and tracking a location of a stolen vehicle according to embodiments of the present disclosure is able to accurately check and track the location of the stolen vehicle even without a separate network-based positioning process, because a radial pattern radius corresponding to location included in each of pieces of relay information can determined based on a hop count value.

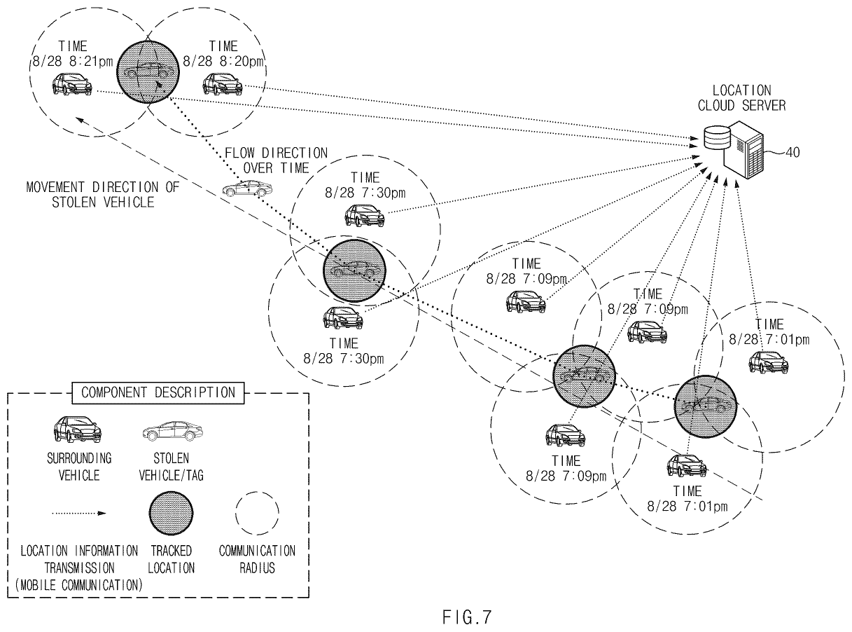

FIG. 7 is a drawing for describing a method for tracking a location of a stolen vehicle via radial pattern analysis according to an embodiment of the present disclosure.

Referring to FIG. 7, if a tracking option between 7 p.m. and 8:30 p.m. on August 28 is selected, a location cloud server 40 may collect location information according to movement of a stolen vehicle for each predefined time zone. The location cloud server 40 may estimate a location of the stolen vehicle corresponding to the time zone via radial pattern analysis based on location information (and/or relay information) received in the time zone.

The location cloud server 40 may connect the location of the stolen vehicle estimated for each time zone, and may track a movement route of the stolen vehicle over time. The location cloud server 40 may predict a road on which the stolen vehicle will drive in the future via movement route tracking and may provide a theft report center server 60 and/or a stolen vehicle owner device 70 and/or a surrounding vehicle 20 and/or a surrounding device 30 with information about the predicted road. In an embodiment, the location cloud server 40 may provide a surrounding vehicle within a certain radius from the currently estimated location of the stolen vehicle with the information about the predicted road. The surrounding vehicle that receives the information about the predicted road may set (e.g., may automatically set) a route depending on the received information and may track the stolen vehicle.

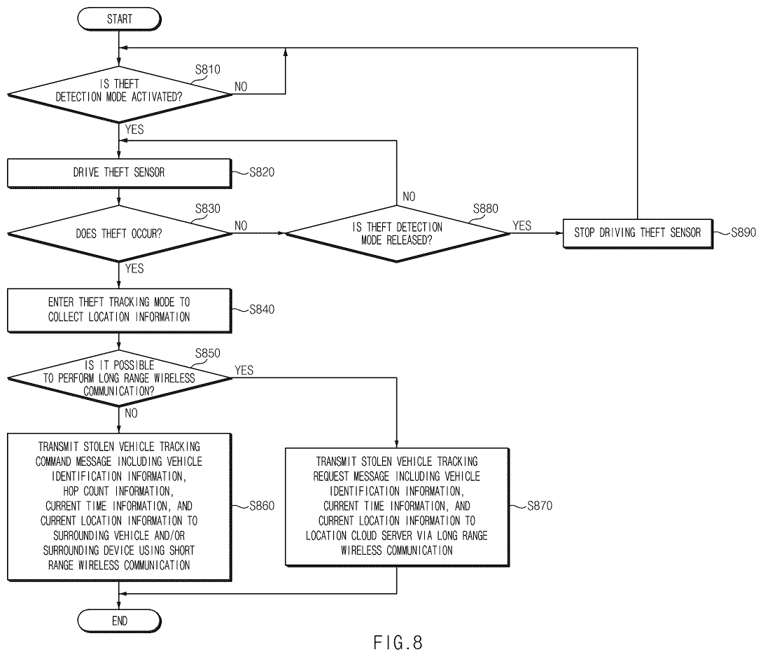

FIG. 8 is a flowchart for describing a method of a stolen vehicle according to embodiment of the present disclosure.

Referring to FIGS. 1, 2, and 8, in an operation S810, a first vehicle 10 that is a stolen vehicle may check whether a theft detection mode is activated.

Based on determining that the theft detection mode is activated as a result of the check, in an operation S820, the first vehicle 10 may activate a theft sensor 270.

In an operation S830, the first vehicle 10 may detect whether theft occurs based on sensing information received from the theft sensor 270.

If the occurrence of the theft is detected, in an operation S840, the first vehicle 10 may enter a theft tracking mode to collect location information from a vehicle infotainment system 220.

In an operation S850, the first vehicle 10 may determine whether it is possible to perform long range wireless communication based on a communication option and a resource state.

Based on determining that it is impossible to perform the long range wireless communication as a result of the determination in the operation S850, in an operation S860, the first vehicle 10 may transmit a stolen vehicle tracking command message including vehicle identification information, hop count information, current time information, and current location information to a surrounding vehicle 20 and/or a surrounding device 30 using short range wireless communication. At this time, the hop count may be 0. The stolen vehicle tracking command message may further include at least one of indoor location information or route setting information to a destination. If it is impossible to collect location information, the first vehicle 10 may transmit a stolen vehicle tracking command message including the remaining information except for current location information to the surrounding vehicle 20 and/or the surrounding device 30 via short range wireless communication.

Based on determining that it is possible to perform the long range wireless communication as a result of the determination in the operation S850, in an operation S870, the first vehicle 10 may transmit a stolen vehicle tracking request message including vehicle identification information, current time information, and current location information to a location cloud server 40 via the long range wireless communication. The stolen vehicle tracking request message may further include at least one of indoor location information or route setting information to the destination. If it is impossible to collect location information, the first vehicle 10 may transmit a stolen vehicle tracking request message including the remaining information except for the current location information to the location cloud server 40. In this case, the location cloud server 40 may request a network 80 to perform network-based positioning for the stolen vehicle. The network 80 may measure a location of a stolen vehicle based on a propagation arrival time between base stations and the stolen vehicle. As an example, the network 80 may measure the location of the stolen vehicle using an observed time difference of arrival (OTDOA) scheme, which is a scheme for predicting a location of a terminal based on latency until signals of base stations arrive at the terminal. The network 80 may transmit location information measured for the stolen vehicle to the location cloud server 40.

If a theft detection mode is released while a theft sensor 270 is being activated, in operations S880 and S890, the first vehicle 10 may stop driving the theft sensor 270 and may return to the operation S810.

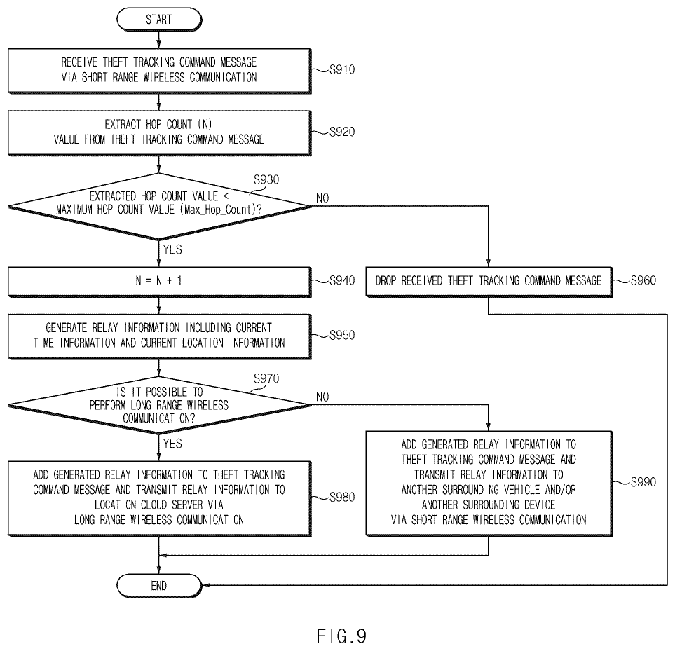

FIG. 9 is a flowchart for describing a method performed by a vehicle or a device located around (e.g., near or on the vicinity of) a stolen vehicle, according to embodiment of the present disclosure.

The description below is provided with reference to an example method performed by a vehicle located around (e.g., near or on the vicinity of) a stolen vehicle.

Referring to FIGS. 1, 2, and 9, in an operation S910, a surrounding vehicle 20 may receive a theft tracking command message via short range wireless communication.

In an operation S920, the surrounding vehicle 20 may extract a hop count (N) value from the received theft tracking command message.

In an operation S930, the surrounding vehicle 20 may compare the extracted hop count value with a certain maximum hop count value Max_Hop_Count.

Based on determining that the extracted hop count value is less than the maximum hop count value as a result of the comparison in the operation S930, in operations S940 and S950, the surrounding vehicle 20 may increase the hop count value by 1 and may generate relay information including current time information and current location information.

On the other hand, based on determining that the extracted hop count value is greater than or equal to the certain maximum hop count value as a result of the comparison in the operation S930, in S960, the surrounding vehicle 20 may ignore and drop the received theft tracking command message.

In an operation S970, the surrounding vehicle 20 may determine whether it is possible to perform long range wireless communication.

Based on determining that it is possible to perform the long range wireless communication as a result of the determination in the operation S970, in an operation S980, the surrounding vehicle 20 may add the generated relay information to the received theft tracking command message and may transmit the theft tracking command message to a location cloud server 40 via the long range wireless communication.

On the other hand, based on determining that it is impossible to perform the long range wireless communication as a result of the determination in the operation S970, in an operation S990, the surrounding vehicle 20 may add the generated relay information to the received theft tracking command message and may transmit the theft tracking command message to another surrounding vehicle and/or another surrounding device via short range wireless communication.

If it is impossible to check a current location, the surrounding vehicle 20 according to an embodiment may generate relay information that does not include current location information.

The operations according to the communication option and the resource state of the surrounding vehicle and the surrounding device, that are described in FIG. 9, are summarized in Table 1 below.

TABLE 1

| Long range | | | |
|---|---|---|---|
| wireless | | Communi- | |
| communi- | | cation | |
| cation | GPS | scheme | Notes |
| ◯ | ◯ | Long range | add its location information to the |
| | | | received theft tracking command |
| | | | message and update the hop count |
| | | | (N = N + 1) to transmit the theft |
| | | | tracking command message to the |
| | | | location cloud server |
| ◯ | X | Long range | update only the hop count of the |
| | | | received theft tracking command |
| | | | message (N = N − 1) to transmit the |
| | | | theft tracking command message to |
| | | | the location cloud server |
| X | ◯ | Short | add its location information to the |
| | | range | received theft tracking command |
| | | | message and update the hop count |
| | | | (N = N + 1) to transmit the theft |
| | | | tracking command message to the |
| | | | surrounding vehicle and/or the |
| | | | surrounding device |
| X | X | Short | update only the hop count of the |
| | | range | received theft tracking command |
| | | | message (N = N − 1) to transmit |
| | | | theft tracking command message to |
| | | | the surrounding vehicle and/or the |
| | | | surrounding device |

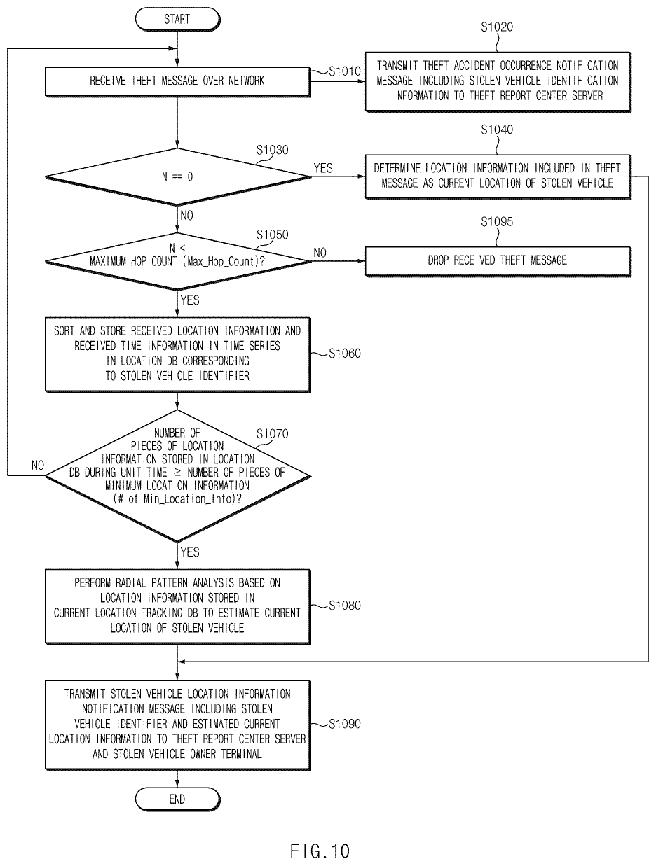

FIG. 10 is a flowchart for describing a method of a location cloud server, according to embodiment of the present disclosure.

Referring to FIGS. 1 and 10, in S1010, a location cloud server 40 may receive a theft message over a network 80. In an embodiment, the theft message may include a theft tracking command message receive a surrounding vehicle or a surrounding device around a stolen vehicle and a theft tracking request message directly received from the stolen vehicle. The theft message may include vehicle identification information for identifying the stolen vehicle, at least one piece of location information, information about a time when the location information is collected, and hop count (N) information.

When the theft message is received, in an operation S1020, the location cloud server 40 may transmit a theft accident occurrence notification message including stolen vehicle identification information to a theft report center server 60.

In an operation S1030, the location cloud server 40 may check whether a hop count extracted from the theft message is 0. Based on determining that the extracted hop count is not 0 as a result of the check in the operation S1030, in an operation S1050, the location cloud server 40 may compare the extracted hop count with a predetermined maximum hop count Max_Hop_Count.

Based on determining that the extracted hop count is less than the maximum hop count as a result of the comparison in the operation 1050, in an operation S1060, the location cloud server 40 may sort and store the received location information and the received time information in time series in a location database (DB) corresponding to a stolen vehicle identifier.

In an operation S1070, the location cloud server 40 may compare the number of pieces of location information stored in the location DB corresponding to the stolen vehicle identifier during a unit time with the number of pieces of minimum location information (# of Min_Location_Info). In an embodiment, the number of the pieces of minimum location information may be determined based on verification via a prior experiment with regard to accuracy and reliability required to estimate a location of a stolen vehicle.

Based on determining that the number of the pieces of location information stored in the location DB corresponding to the theft vehicle identifier during the unit time as a result of the comparison in the operation S1070 is greater than or equal to the number of the pieces of minimum location information, in an operation S1080, the location cloud server 40 may perform radial pattern analysis based on location information stored in a current location tracking DB to estimate a current location of the stolen vehicle.

In an operation S1090, the location cloud server 40 may transmit a stolen vehicle location information notification message including the stolen vehicle identifier and the estimated current location information to a theft report center server 60 and a stolen vehicle owner terminal 70.

Based on determining in the operation S1030 that the hop count is 0, in an operation S1040, the location cloud server 40 may determine the location information included in the theft message as a current location of the stolen vehicle.

The location cloud server 40 may transmit the stolen vehicle location information notification message including the stolen vehicle identifier and the estimated current location information to the theft report center server 60 and the stolen vehicle owner terminal 70.

Based on determining that the hop count is greater than or equal to the maximum hop count as a result of the comparison in the operation S1050, in an operation S1095, the location cloud server 40 may drop the received theft message. In an embodiment, the location cloud server 40 may transmit Etm for instructing to stop relay transmission corresponding to the stolen vehicle to a vehicle or a device that transmits the theft message in which the hop count is greater than or equal to the maximum hop count. The vehicle or the device which receives Etm may transmit Etm to another surrounding vehicle and/or another surrounding device. As a result, it may be controlled that relaying for the stolen vehicle is not performed any longer.

As described in the embodiments above, the method for tracking the stolen vehicle according to the present disclosure may adaptively use a short range wireless communication means, such as Bluetooth capable of being mounted on a device as small as a fingernail, depending on a communication option (e.g., whether or not long range communication and/or short range communication are available) and a resource state of the vehicle to collect location information of a vehicle and a device around (e.g., near or in the vicinity of) a stolen vehicle as well as location information of the stolen vehicle and perform radial pattern analysis, thus more robustly and accurately estimating and tracking the location of the stolen vehicle. The method according to the present disclosure may be used to check and track a location of the stolen vehicle or device and may be used to check a location of a device of a user who wants to identify a current location, even when there is no theft.

The method for tracking the stolen vehicle according to embodiments of the present disclosure may perform relay communication together with regard to resource states of a surrounding vehicle and surrounding devices, that may deliver information of a stolen vehicle to a location cloud server, as well as the stolen vehicle, thus playing a cooperative role in tracking the location of the stolen vehicle regardless of whether a communication option and a resource are sufficient or insufficient. In other words, as it is possible for any vehicle and device to be used to estimate and track the location of the stolen vehicle regardless of the resource or the communication option, it is possible to very accurately and quickly track the location of the stolen vehicle.

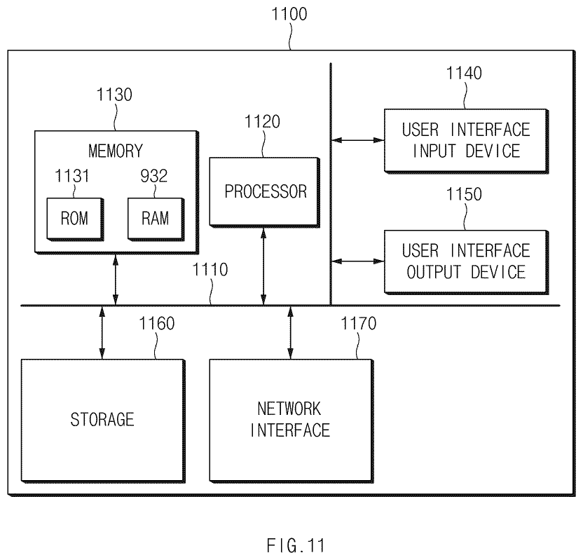

FIG. 11 illustrates a computing system according to an embodiment of the present disclosure.

Referring to FIG. 11, a computing system 1100 may include at least one processor 1120, a memory 1130, a user interface input device 1140, a user interface output device 1150, a storage 1160, and a network interface 1170, which are connected with each other via a bus 1110.

The processor 1120 may be a central processing unit (CPU) or a semiconductor device that processes instructions stored in the memory 1130 and/or the storage 1160. The memory 1130 and the storage 1160 may include various types of volatile or non-volatile storage media. For example, the memory 1130 may include a ROM (Read Only Memory) 1131 and a RAM (Random Access Memory) 1132.

Thus, the operations of the method or the algorithm described in connection with the embodiments disclosed herein may be embodied directly in hardware or a software module executed by the processor 1120, or in a combination thereof. The software module may reside on a storage medium (i.e., the memory 1130 and/or the storage module 1160) such as a RAM, a flash memory, a ROM, an EPROM, an EEPROM, a register, a hard disc, a removable disk, and a CD-ROM. As an example, the processor 1120 may be mounted on at least one of the vehicles 10 and 20, the location cloud server 40, and the user devices 30 and 70, which are described above.

The storage medium may be coupled to the processor 1120. The processor 1120 may read out information from the storage medium and may write information in the storage medium. Alternatively, the storage medium may be integrated with the processor 1120. The processor 1120 and storage medium may be implemented with an application specific integrated circuit (ASIC). The ASIC may reside in the control unit in the vehicle. Alternatively, the processor 1120 and storage medium may reside as separate components in the vehicle control unit.

Embodiments of the present disclosure may provide the method and the apparatus for tracking the location of the stolen vehicle using the surrounding vehicle and the surrounding device.

Furthermore, embodiments of the present disclosure may provide the method and the apparatus for tracking the location of the stolen vehicle to check and track a location of the stolen vehicle and/or a device regardless of communication options and/or resources of all vehicles and/or devices.

Furthermore, embodiments of the present disclosure may provide the method and the apparatus for tracking the location of the stolen vehicle to apply a separate vehicle setting mode called a theft detection mode and clearly identify general vehicle usage and theft to respond to the theft.

Furthermore, embodiments of the present disclosure may provide the method and the apparatus for tracking the location of the stolen vehicle using a surrounding vehicle and a surrounding device to adaptively interwork with the surrounding vehicle and/or the surrounding device via short range wireless communication depending on a state and a resource availability state of the stolen vehicle upon theft detection to provide location information to more accurately and quickly check and track a vehicle location.

Furthermore, embodiments of the present disclosure may provide the method and the apparatus for tracking the location of the stolen vehicle using the surrounding vehicle and the surrounding device to limit a hop count of relay communication using short range wireless communication to prevent data explosion on the network.

Furthermore, embodiments of the present disclosure may provide the location cloud server for performing tracking radial pattern analysis based on location information collected from a surrounding vehicle and/or a surrounding device to check and track a location of a stolen vehicle to quickly respond to a vehicle theft situation via real-time interworking with a theft report center and a stolen vehicle owner terminal.

Furthermore, embodiments of the present disclosure may securely and accurately provide a server with location information corresponding to a stolen vehicle regardless of a communication option and a resource state of a vehicle and a device.

In addition, various effects ascertained directly or indirectly through the present disclosure may be provided.

Hereinabove, although the present disclosure has been described with reference to embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

Accordingly, embodiments of the present disclosure are intended not to limit but to explain the technical idea of the present disclosure, and the scope and spirit of the invention is not limited by the above embodiments. The scope of the present disclosure should be construed on the basis of the accompanying claims, and all the technical ideas within the scope equivalent to the claims should be included in the scope of the present disclosure.

What is claimed is:

1. A computing device provided in a location cloud server interworking with a vehicle and a device over a network, the computing device comprising:
a memory storing computer-readable instructions; and
a processor configured to execute the computer-readable instructions,
wherein the processor is configured to:
receive at least one theft message including identification information of a stolen vehicle and a hop count over the network, and
estimate and/or track a location of the stolen vehicle via radial pattern analysis based on the at least one theft message.

2. The computing device of claim 1, wherein the at least one theft message includes a first theft message directly received from the stolen vehicle and a second theft message received from an adjacent vehicle and/or an adjacent device around the stolen vehicle, and
wherein information included in the first theft message and the second theft messages is dynamically generated according to a communication option and a resource state of the vehicle and/or the device.

3. The computing device of claim 2, wherein the second theft message is transmitted by the stolen vehicle via short range wireless communication, is relayed and updated to at least one adjacent vehicle and/or at least one adjacent device, and is received via long range wireless communication,
wherein an initial hop count of the second theft message transmitted by the stolen vehicle is set to 0, and
wherein the hop count increases by 1 as the second theft message is relayed by each of the at least one adjacent vehicle and/or at least one adjacent device.

4. The computing device of claim 3, wherein the second theft message includes relay information corresponding to each of the at least one adjacent vehicle and/or the at least one adjacent device, and
wherein the relay information includes at least one of location information or time information when the relay information is generated, according to the communication option and the resource state of the adjacent vehicle and/or the adjacent device.

5. The computing device of claim 4, wherein:
the hop count increases by a number of times that the second theft message is relayed via the short range wireless communication; and
a radial pattern radius corresponding to a current location of the adjacent vehicle or the adjacent device is determined based on the hop count included in the second theft message.

6. The computing device of claim 5, wherein the processor is configured to:
perform the radial pattern analysis based on determining that the number of the second theft messages, related to the stolen vehicle, received during a unit time is greater than or equal to a certain reference value;
estimate an area where radial patterns for each second theft message overlap with each other as a current location of the stolen vehicle; and
connect the estimated current location over time to track a movement route of the stolen vehicle.

7. The computing device of claim 5, wherein relaying of the second theft message via the short range wireless communication is stopped based on the increased hop count being greater than or equal to a certain maximum hop count.

8. The computing device of claim 5, wherein the processor is configured to:
collect information about a traffic state of the network; and
transmit an end of tracking message to the adjacent vehicle and/or the adjacent device that transmitted the second theft message via the long range wireless communication, based on the traffic state.

9. The computing device of claim 3, wherein:
the short range wireless communication includes at least one of Bluetooth communication, wireless-fidelity (Wi-Fi) communication, ZigBee communication, or ultra wideband (UWB) communication; and
the long range wireless communication includes at least one of long term evolution (LTE) communication, 5G new radio access network (RAN) (5G NR) communication, or dedicated vehicle wireless communication.

10. A computing device provided in a vehicle interworking with a location cloud server over a network, the computing device comprising:
a memory storing computer-readable instructions; and
a processor configured to execute the computer-readable instructions,
wherein the processor is configured to:
detect whether theft occurs, based on determining that a theft detection mode is activated,
enter a theft tracking mode based on determining that the theft is detected,
determine a communication scheme corresponding to a communication option and a resource state of the vehicle, and
transmit a theft message using the determined communication scheme,
wherein
the theft message is directly transmitted to the location cloud server based on the determined communication scheme being long range wireless communication, and
the theft message is relayed and transmitted to the location cloud server via an adjacent vehicle and/or an adjacent device around the vehicle based on the determined communication scheme being short range wireless communication.

11. A method for tracking a location of a stolen vehicle in a location cloud server interworking with a vehicle and a device over a network, the method comprising:
receiving, at the location cloud server, at least one theft message including identification information of a stolen vehicle and a hop count over the network; and
estimating and/or tracking, by the location cloud server, a location of the stolen vehicle via radial pattern analysis based on the at least one theft message.

12. The method of claim 11, wherein the at least one theft message includes a first theft message directly received from the stolen vehicle and a second theft message received from an adjacent vehicle and/or an adjacent device around the stolen vehicle, and
wherein information included in the first theft message and the second theft message is dynamically generated according to a communication option and a resource state of the vehicle and/or the device.

13. The method of claim 12, wherein the second theft message is transmitted by the stolen vehicle via short range wireless communication, is relayed and updated to at least one adjacent vehicle and/or at least one adjacent device, and is received via long range wireless communication,
wherein an initial hop count of the second theft message transmitted by the stolen vehicle is set to 0, and
wherein the hop count increases by 1 as the second theft message is relayed by each of the at least one adjacent vehicle and/or at least one adjacent device.

14. The method of claim 13, wherein the second theft message includes relay information corresponding to each of the at least one adjacent vehicle and/or the at least one adjacent device, and
wherein the relay information includes at least one of location information or time information when the relay information is generated, depending on the communication option and the resource state of the adjacent vehicle and/or the adjacent device.

15. The method of claim 14, wherein:
the hop count increases by a number of times that the second theft message is relayed via the short range wireless communication; and
a radial pattern radius corresponding to a current location of the adjacent vehicle or the adjacent device is determined based on the hop count included in the second theft message.

16. The method of claim 15, wherein the radial pattern analysis is performed based on the number of the second theft messages, related to the stolen vehicle, received during a unit time being greater than or equal to a certain reference value,
wherein an area where radial patterns for each second theft message overlap with each other is estimated as a current location of the stolen vehicle, and
wherein the estimated current location is connected over time to track a movement route of the stolen vehicle.

17. The method of claim 15, wherein relaying of the second theft message via the short range wireless communication is stopped based on the increased hop count being greater than or equal to a certain maximum hop count.

18. The method of claim 15, further comprising:
collecting, by the location cloud server, information about a traffic state of the network; and
transmitting, by the location cloud server, an end of tracking message to the adjacent vehicle and/or the adjacent device that transmitted the second theft message via the long range wireless communication, depending on the traffic state.

19. The method of claim 13, wherein:
the short range wireless communication includes at least one of Bluetooth communication, wireless-fidelity (Wi-Fi) communication, ZigBee communication, or ultra wideband (UWB) communication; and
the long range wireless communication includes at least one of long term evolution (LTE) communication, 5G new radio access network (RAN) (5G NR) communication, or dedicated vehicle wireless communication.
